(19) United States
(12) Patent Application Publication
(10) Pub. No.: US 2017/0001654 A1
(43) Pub. Date: Jan. 5, 2017

(54) STACKABLE LID SYSTEM WITH SIDE LATCH CLOSURE FOR COLLAPSIBLE CART

(71) Applicant: Cathleen S. Obrien, Temecula, CA (US)

(72) Inventor: Cathleen S. Obrien, Temecula, CA (US)

(21) Appl. No.: 14/788,337

(22) Filed: Jun. 30, 2015

(51) Int. Cl. B62B 1/12; B62B 1/14

(52) U.S. Cl. CPC B62B 1/12; B62B 1/14

(57) ABSTRACT

Whereby during use of a folding rolling cart user can place the embodiment of the lid system which consists of 2 separate parts, a lid and desk top insert so that you can increase the amount that you carry by stacking additional items onto the recessed lid surface. Additionally place and safeguard items such as lap tops and cell phones onto the desk top insert for use while working remotely. These two embodiments fit inside one another to allow for efficient storage onto the back housing. The side latch handles then lock the lids onto the cart while said handle also holds and locks the cart closed for efficient storage whereby safeguarding the lid system from being lost.

### CROSS REFERENCE TO RELATED APPLICATIONS

None

### FEDERALLY SPONSORED RESEARCH

None.

### BACKGROUND OF INVENTION

Field of the Invention

This invention relates to the field of collapsible rolling carts that transport various kinds of items for individual use. More specifically the invention enables the user to better safeguard, organize, and transport items with the lid system while offering a place to store the lid system while not being used. Independent housing attaches to the back of a cart that enables user to store and carry lid system while side latches hold the cart closed.

Description of Related Art

There are many collapsible rolling carts on the market used to transport items for individual use. Many of these are molded plastic with holes in the sides and no solid walls to insure that items stay in the cart while rolling. Typically these carts are sold without lids so that the user cannot protect the contents of the cart and or stack additional items on top.

The existing plastic cart is regularly used in a wide variety of professions, teachers, attorneys, sales people, doctors, any job where people need to transport business documents or supplies. While some carts do provide lids they are flat and smooth on top so even if cords are used to tie items down they easily slide off of the slick plastic surface. If a lid is provided with the cart they rarely have a place to store them so often get lost or misplaced.

Most existing carts today have limited their usage because items most critical such as lap tops, cell phones or modern electronics are too valuable to transport in a typical cart for risk being damaged or stolen because of the lack of a lid. Users therefore carry additional bags to transport these items which limit or restrict the extent of usefulness of the cart. Additionally closing the existing carts is often done with a flimsy plastic piece that is in effective in holding a cart closed.

### BRIEF SUMMARY OF THE INVENTION

The present invention provides a two part lid and lid insert or desk top that each have a different function. The lid is designed to be held securely on top of the cart to cover and protect all contents. Additionally the lid is designed with a ¾″ recessed indentation on the top surface to stack additional items and hold them in place while the cart is moving. An elongated lid edge further protects cart contents from exposure to the elements. While the lid sits firmly on top of the cart it is designed to further include another lid insert to expand its function. This additional element is a desk top insert that snaps into recessed grooves of the lid that enables it to function as a mobile desk. The cart which was previously limited as a means of transporting materials is now able to provide a stable surface to hold a lap top, phone, drink and assorted office materials. The lid system can also be adapted for many other uses.

When not in use the desk top and lid are designed to fit one inside of the other for more efficient storage. They are then stored on the back housing of the cart shelf where the right and left handles pulls down to lock each side in place while in motion or stationary. On the back of the cart is a custom housing that holds a shelf with a right and left latches designed to do two things at once. When the right and left side latches are turned it fits securely over the desk top/lid duo to lock it in place while simultaneously grabbing a clasp on the side of the cart to hold the cart closed.

These inventions solve a variety of existing problems, it provides cart accessories that can now be used to safely store and transport items that had to previously be carried separately. They provide a method and platform to efficiently function while enabling the user to safely keep them stored. The newly designed lid system now enables the user to add additional storage on top while maintaining the stability of the cart and items being transported.

### DRAWINGS

FIG. 1 is a perspective view of the front left side of cart showing the invention on the top in use.

FIG. 2 is an exploded perspective showing one option of how the lid is removed and desk top stored inside the cart in accordance with one embodiment.

FIG. 3 is a top perspective view showing how said lid fits into the cart in accordance with one embodiment.

FIG. 4 is a top perspective view of the lid.

FIG. 5 is a top exploded perspective of how the embodiments may be optionally used.

FIG. 6 is a top exploded perspective of an additional version of how the embodiments may be used.

FIG. 7 is a side exploded perspective view of how the embodiments can be used while the cart is in motion.

FIG. 8 is a front perspective showing a closer detail of how the embodiment is held in place.

FIG. 9 exploded perspective of how the desk top snaps into lid.

FIG. 10 side view of the lid and desk top consolidated.

FIG. 11 perspective side view of the lid and desk top stored on the back of the cart

FIG. 12 front perspective of the lid and desk top storage

FIG. 13 back perspective of the lid and desk top stored on the back of the cart

FIG. 14 back perspective of storage housing, shelf, and handles

FIG. 15 close up of storage closure latch

FIG. 16 side perspective of storage closure latch

FIG. 17 back perspective of cart back with housing removed

### REFERENCE NUMERALS

A folding cart on wheels open
A1 folding cart on wheels closed
A2 folding cart on wheels with rear housing removed
B lid
B1 lid front edge
B2 lid rear edge
B3 lid tab handles
B4 lid recessed top surface
C desk top insert
C1 desk top indented side finger pull
C2 desk top tabs
D side closure latch
Dr right side closure latch
Dl left side closure latch
D1 side closure tab
D2 metal tube for latch mechanism
D3 metal tube mounting bracket
D4 metal rod mounting holes
D5 side closure latch mounting arm
E rear cart housing for closure latch and shelf
E1 storage shelf mounted on cart housing

### DETAILED DESCRIPTION—FIG. 1-4

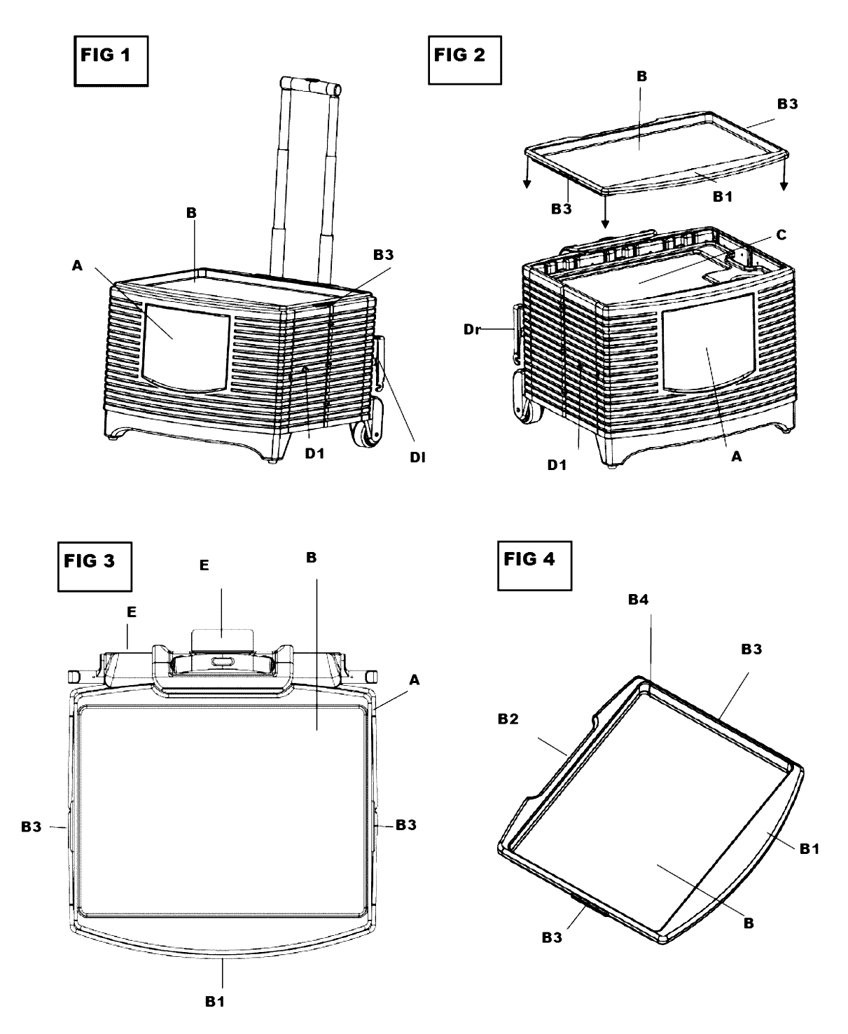

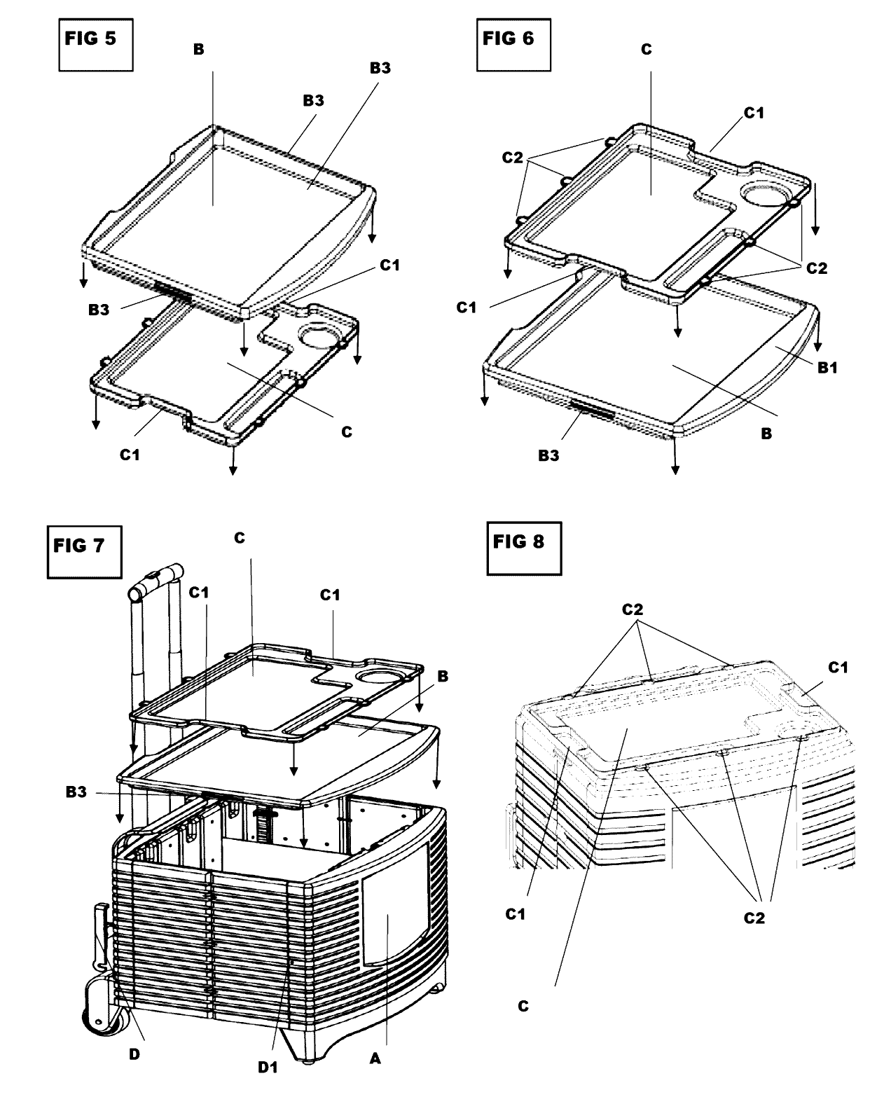

One embodiment of the invention is illustrated in FIG. 1, (front perspective) FIG. 2 (exploded perspective) FIG. 3 (top view) and FIG. 4 (top right view). The Lid in FIG. 1 is configured to fit on top of a collapsible rolling cart on wheels. The lid in FIG. 1-FIG. 4 is fabricated in one solid piece of injection molded plastic. The embodiment can also be manufactured in other materials such as cardboard, poly carbon and or combinations thereof. The lid top surface has a recessed area with a depth of roughly 1″ that covers the entire top surface (FIG. 4 B3). The recessed top surface facilitates the ability to place additional items on the lid while keeping the items from sliding off the sides. Most lids currently on the market have a flat top surface which does not allow the user to stack and carry more items. The edge of the lid extends out to the rim of the cart at its front, back, right, and left (FIG. 3) wherein further protecting the contents of the cart. Tab handles are located on the right and left side (FIG. 4, B3) where they protrude to lift lid from the cart. The embodiment can be adapted to a wide variety of shapes, for example square or severe rectangle that will not restrict its function. Additionally this embodiment can also be adapted for use on many items not limited to rolling carts.

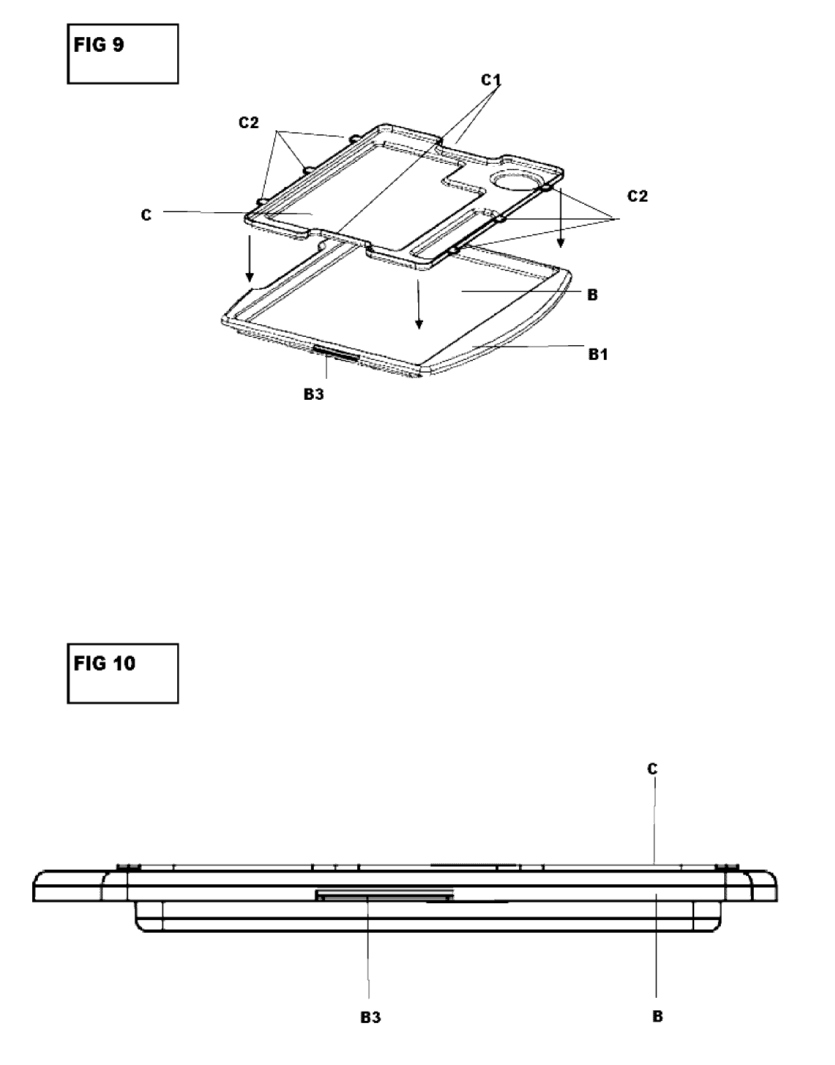

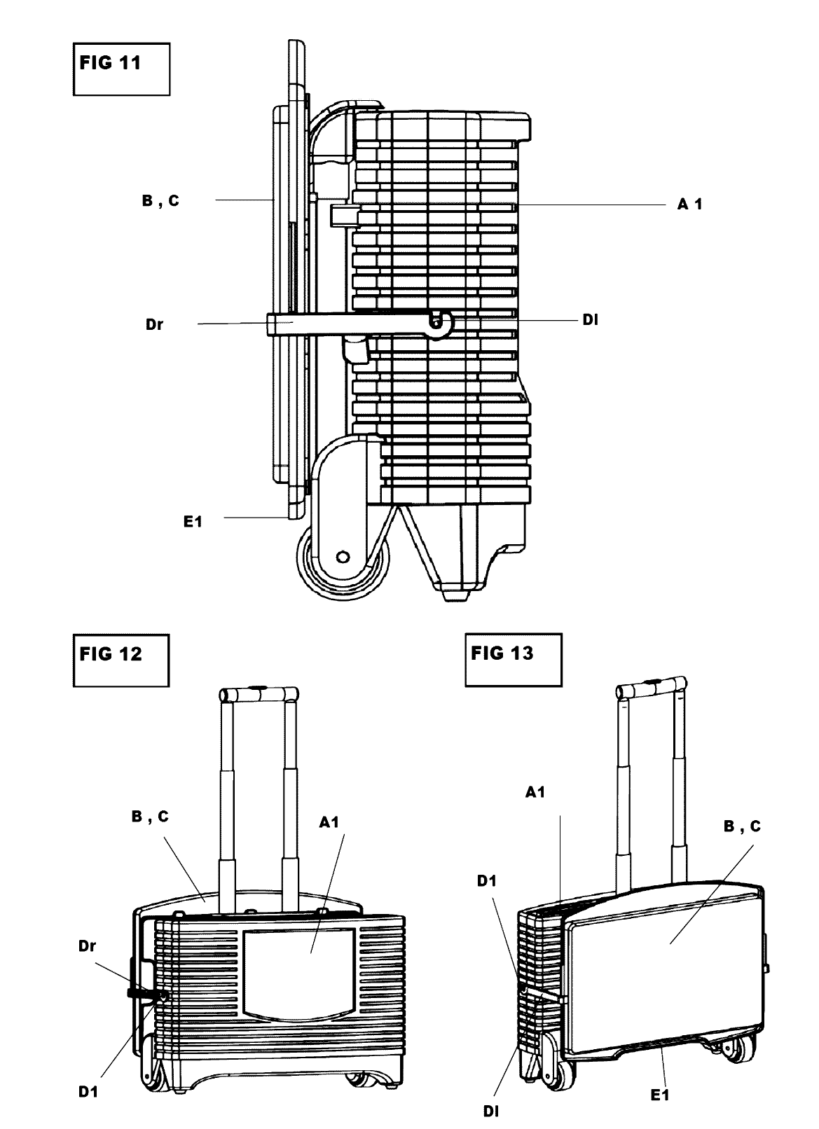

FIG. 6 is an example of how the lid system functions. The desk top insert is one solid piece of injection molded plastic with protruding tabs located on the front and back to sit inside of said lid. The tabs on the insert desk top (FIG. 6 c2) hold it in place inside of said lid so that it will not move while in use, which is important as this pieces is designed to transport electronics safely. FIG. 8 further illustrates how the lid and desk top insert consolidated into one piece is used inside of a cart. FIG. 10 is a side horizontal view showing how the two consolidated pieces look. FIG. 11 is a side view of the consolidated lid and desk top insert stored and locked in place on the back housing of a cart. FIG. 13 is a rear view illustrating the two embodiments consolidated resting on the housing shelf and held in by the cart side latches.

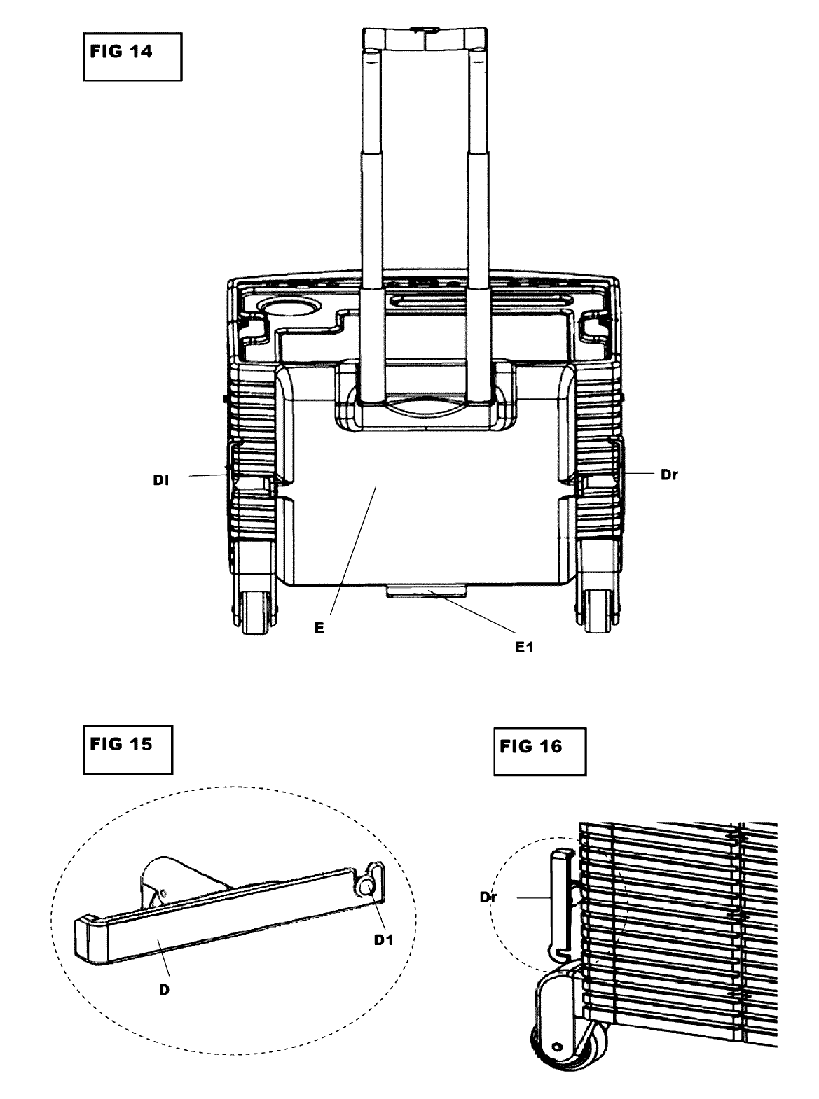

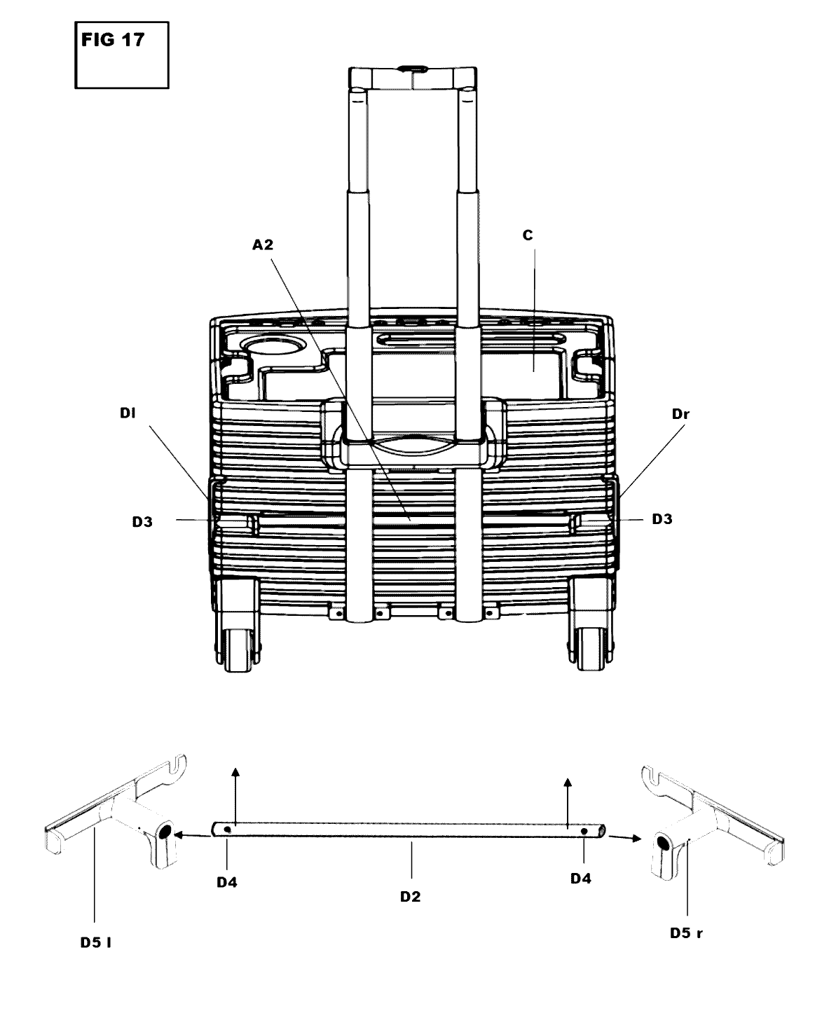

The rear view of FIG. 14 E shows the embodiment housing cover made of injection molded plastic that is attached to the back of a cart. This embodiment is a single molded plastic piece that has a shelf at the bottom and molded mounting brackets on the outer right and left side(FIG. 17 D3 D2) to hold right and left latch. (FIG. 15, FIG. 16). The embodiment in FIG. 4 when not in use rests upright on the back housing shelf (FIG. 14 E1) and is locked into place by the latches shown in (FIG. 16). When said latches are turned from an upright position (FIG. 16 Dr) to a horizontal position the lid edge on the left grabs the edge of the lid (FIG. 4) and holds it in place. One edge of the latch (FIG. 15, D) is angled at 90° to grab and hold the lid edge (FIG. 11 Dr) while the opposite end of said latch (FIG. 15 D1) has a vertical groove designed to grab and wrap around a pin located on the side of the cart (FIG. 11 Dl) to lock the cart in a closed position. The latches are made of injection molded plastic and locked onto the housing via a metal rod (FIG. 17) with a metal pin.

The embodiment of FIG. 15 provides two different functions; one that acts as a latch to hold a cart closed, the second to lock the lid in place for storage. The latches function independently and are not subject to both being in use in order to work successfully.

The said housing cover(FIG. 14 E) when removed exposes the metal rod currently manufactured in aluminum and mounting bracket that is fixed to the cart back to hold the latch handles. The rod can also be manufactured in many material variations for example steel or combinations thereof and or plastics. These latches are attached to the right and left ends of a metal rod that runs horizontally across the back a cart(FIG. 17 D2, D5l D5r.) The metal rod is hollow and held in place horizontally across the cart back by a separate mounting bracket that is attached directly onto the cart back (FIG. 17 D2 D3). The metal rod is placed through the mounting bracket holes on the cart) then the latches are slid onto the right and left ends of the rod (FIG. 17 D5r, D5l) and secured with pins that fit through holes in metal rod (FIG. 17 D2, D4). Once the rod is secured to the right and left latch they now rotate in unison when the latch is being used. The back housing is then placed over the latch mounting bracket and affixed to the cart back as a means of providing both protection for said brackets and an additional storage area.

Further since all rolling carts move they typically have handles as a means to pull them, the said housing additionally acts as a way to protect and prolong the life of this handle system.

Storage on the shelf back (FIG. 14 E, E 1) can be used to transport a wide variety of items and is not limited to storage of the lid system.

### Advantages

From the above description a number of advantages of some embodiments of my lid and housing become evident:
(a) a lid that allows you to stack boxes on top without sliding off the side provides a means to carry substantially more while safekeeping materials.
(b) storing the lid on the back enables the user to always have it ready, find it easily, store it efficiently. Most carts currently on the market do not provide a place to store the lid and therefore regularly are lost or misplaced.
(c) The lid extends to the edge of the cart in such a way that it protects the interior and its contents from the elements wherein enabling the cart to be more usable.
(d) when the desk top is placed for use inside the lid it offers the user a safe and stable place to put their electronics and keep their things organized while in use. Carts are used to transport items to a secondary location and this creates a remote platform to function from.
(e) side latches grip and hold a cart snugly closed while being easy to use. Both right and left latch being attached to one mechanism makes it easier for the customer to operate.
(f) when the cart is in use with the lid on top the back shelf can be used to carry additional items which improves overall efficiency in the transportation of materials.
(g) The lid can be used and adapted to many different boxes not just for rolling carts.
(h) Manufacturing most of the components in injection molded plastic makes them highly durable and long lasting. Additionally these pieces can be made with recycled materials and when no longer in use can also be recycled. They can also be manufactured in other materials.
(i) back housing cover protects not only the latches and its mechanism but any handles used and will therefore extend the life of these parts by keeping them safe from the elements and damage in use. These components are less likely to be damaged while protected by a cover.
(j) all of the main components are attached with screws while enables for parts to easily replaced should the need arise.
(k) the components are streamlined and elegant so that if it is used in a professional environment they are aesthetically pleasing rather than looking industrial therefore expanding the practical use.

Although the description above contains many specifics these should not be construed as limiting the scope of embodiments but merely providing examples of some of the presently preferred embodiments. For example the shape of the lid can be adapted to fit another size cart while maintaining the embodiment of a recessed surface and protective edge. The lid can additionally be adapted for used in other materials as many products require lids for example cardboard box.

Thus the scope of the embodiments should be determined by the appended claims and their legal equivalents rather than by examples given.

Having described my invention, I claim:

1. A stackable lid system with self storage housing and side latches consisting of:
a. The lid of claim 1 wherein said top surface has a recessed area so as to provide a means to place items on top in a secure way and keep items from sliding off of said lid while in use. This feature add twice the storage that a standard cart typically provides.
b. The lid edge of claim 1 further provides a surface area around the lid edge as a means of protecting interior contents.
c. The Lid system of claim 1 wherein said lid has an additional element used to provide further stability of electronics or personal items that need protection while the cart is in use. This additional feature or desk top insert sits inside of the lid in claim 1 wherein providing additional type of storage and use that previously required the user to carry in an additional bag. This feature also allow the user to have a remote desk top to work from when there is no flat surface available.

2. A storage housing consisting of:
a. A rigid molded housing of claim 1 wherein said means for holding the lid system on the lower shelf located on the base of said housing.
b. The housing method of claim 1 holds and encases the handles and handle mechanisms whereby said housing protects and provides a means for holding said handles while in use.
c. The storage housing of claim 1 acts to encase the handles located on a cart rear back with its rigid molded material.

3. A side latch closures consisting of:
a. The method of holding said lid system of claim 1 onto the shelf housing of claim 2 where in one end of said handles is L shaped to grab and hold and the lid system and lock it in place. The opposite end has a u shape molded into said latch to hold a pin located on the side of a cart whereby holding the cart in the closed position. The said latch therefore has two specific modes of operation.
b. The side latch performs two separate functions yet is attached to one mechanism that allows both functions to happen simultaneously.
